(19) United States
(12) Patent Application Publication
(10) Pub. No.: US 2005/0239003 A1
(43) Pub. Date: Oct. 27, 2005

(54) Pyroceramic material with a base of silica and tin dioxide, particularly for optical applications, and the corresponding process of fabrication

(76) Inventors: Norberto Chiodini, Milano (IT); Alberto Paleari, San Donato Milanese (IT); Giorgio Spinolo, Cinisello Balsamo (IT)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 10/505,957

(22) PCT Filed: Feb. 28, 2003
(86) PCT No.: PCT/IB03/00773

§ 371 Date: Jun. 15, 2005

(30) Foreign Application Priority Data
Feb. 28, 2002 (IT) MI2002A000405

(51) Int. Cl. G03C 5/00

(52) U.S. Cl. 430/321

(57) ABSTRACT

A glass ceramic material with a base of silica and tin dioxide: the material has a vitreous silica matrix, in which there are dispersed crystalline aggregates of tin dioxide having submicrometric or nanometric dimensions, the dimensions being obtained by means of appropriate control of specific operating parameters of the process of preparation. The material has excellent values of optical transmission in the visible and in the near infrared and high properties of photosensitivity and optical non-linearity, which render the material suitable, in particular, for use in devices for optical telecommunications (integrated in optical fibre or on planar waveguide or in three-dimensional devices) and memories, the devices being obtainable, for example, by direct writing or using laser interferometric techniques.

### TECHNICAL FIELD

The present invention relates to a pyroceramic material with a base of silica and tin dioxide, particularly for optical applications, and to the corresponding process of fabrication.

### BACKGROUND ART

There is known, above all in the field of waveguide devices for optical telecommunications, the use of photosensitive glasses (or, more precisely, photorefractive glasses), which present a substantially permanent variation of index of refraction when exposed to an intense optical radiation. Examples of photosensitive glasses are appropriately doped silica-based glasses. In particular, it is known that the doping of silica with tin, also in the absence of other co-dopants, is able to induce considerable positive variations of index of refraction by exposure to UV radiation, as discussed, for example, in the publication [1] G. Bramble, V. Pruneri and L. Reek, “Photorefractive index gratings in SnO₂:SiO₂ optical fibres”, Appl. Phys. Lett. 76, 807-9, (2000).

However, doping with tin is markedly limited by the low solubility of tin in silica: in fact, for levels of doping higher than approximately 0.5 mol % of tin, there takes place the segregation of tin dioxide SnO₂, which usually leads to an opaque white ceramic material, which is altogether unsuitable for optical applications. These aspects have been exhaustively investigated, for example, in the following publications: [2] G. Carturan, R. Ceccato, R. Campostrini, V. M. Sglavo, “SiO₂/SnO₂ and Sn/Sb-oxide/SiO₂ gel-derived composites”, J. Sol-Gel Sci. Techn. 5, 49-64, (1995); [3] R. Dal Maschio, S. Dirè, G. Carturan, S. Enzo, L. Battezzati, “Phase separation in gel-derived materials, separation and crystallization of SnO₂ within an amorphous SiO₂ matrix” J. Mater. Res. 7, 435-443, (1992); [4] N. Chiodini, F. Morazzoni, A. Paleari, R. Scotti, G. Spinolo, “Sol-gel synthesis of monolithic tin-doped silica glass”, J. Mater. Chem. 9, 2653-2658, (1999); [5] N. Chiodini, F. Meinardi, F. Morazzoni, J. Padovani, A. Paleari, R. Scotti, G. Spinolo, “Thermally induced segregation of SnO₂ nanoclusters in Sn-doped silica glasses from oversaturated Sn-doped silica xerogels”, J. Mater. Chem. 11, 926-29, (2001).

### DISCLOSURE OF INVENTION

It is therefore a purpose of the present invention to provide a new material for optical applications, together with a process of fabrication of said material. In particular, a purpose of the invention is to provide a pyroceramic photosensitive material having non-linear optical properties, which will be suitable for the fabrication of devices in the field of telecommunications and of treatment of optical signals.

The present invention therefore relates to a pyroceramic material with a base of silica and tin dioxide, particularly for optical applications, comprising a matrix of vitreous silica, in which there are dispersed crystalline aggregates of tin dioxide, the material being characterized in that said aggregates have controlled dimensions that are on average lower than a pre-set threshold and such that the material is photosensitive and substantially transparent.

According to a first aspect of the invention, the material has aggregates having, on average, dimensions smaller than approximately 100 nm and preferably smaller than approximately 15 nm. In this case, the material is particularly indicated for applications as photorefractive material.

According to another aspect of the invention, the material has aggregates having dimensions smaller than approximately 2.5 nm and presents non-linear optical properties, which are induced or influenced by quantum-confinement effects, since the dimensions of the aggregates are comparable with the Bohr radius of the first electronic excitation in SnO₂.

The material of the invention is further characterized in that it presents negative variations of refractive index when exposed to intense electromagnetic radiation, and in that it has transmittance in the near IR and in a fair range of the visible corresponding to an attenuation lower than 1 dB/cm.

According to a preferred embodiment, the matrix basically consists of silica and is substantially devoid, apart from the aggregates of tin dioxide, of other dopants.

The material of the invention has a molar content of crystallized tin dioxide in said aggregates of controlled dimensions up to 30%, and preferably of between approximately 1% and approximately 20%.

Substantially, there is provided a material having a vitreous matrix, consisting essentially of silica SiO₂ (substantially pure or possibly doped at a substitutional level), in which there are dispersed inclusions or aggregates of tin dioxide SnO₂ having dimensions on average lower than a critical value, in such a way that the material is substantially transparent (with good optical transmission in the visible and in the near infrared). The material can therefore be defined as being of optical quality and is altogether suitable, for example, for use in devices for optical telecommunications (optical fibres, planar waveguides, etc.).

It has moreover been surprisingly found that the material of the invention presents negative variations of index of refraction, unlike silica glasses doped with substitutional tin (where, as is known, the variation of index of refraction is instead positive).

It has thus been recognized, for the first time in the art, that pyroceramic materials with a silica base with tin in high concentrations become suitable for optical applications in which there are required properties of photosensitivity and optical non-linearity, thanks to the segregation of tin dioxide in aggregates having dimensions smaller than a critical threshold.

The present invention also provides a method for the fabrication of the materials in question, the said method envisaging the adoption, in the framework of a methodology of preparation that is substantially known, of specific solutions that enable, precisely, the control of the dimensions of the aggregates of tin dioxide.

In particular, the invention provides a process for the production of a pyroceramic material having a matrix of vitreous silica, in which crystalline aggregates of tin dioxide of controlled dimensions are dispersed, the process comprising a step of sol-gel reaction of respective precursors of silica and of tin, as well as a step of sintering of the gel resulting from said sol-gel reaction, the process being characterized in that the dimensions of said aggregates of tin dioxide are controlled by varying the concentration of tin in said step of sol-gel reaction and/or the partial pressure of oxygen in said sintering step and/or the maximum temperature reached in said sintering step.

The basic technique of preparation of materials having a matrix of silica with inclusions of tin dioxide is described, for example, in the publications [4] and [5] already cited, the contents of which are here incorporated for reference as regards the parts necessary for an understanding of the present invention. In these publications, there is not, however, provided any technique for control of the dimensions of the aggregates of silicon dioxide, nor is the role of specific process parameters in said dimensional control investigated.

Summarizing what has been exhaustively described in the cited publications, the material according to the invention is produced by means of the sol-gel technique by reaction in the liquid phase, referred to precisely as “sol”. Said technique envisages the hydrolysis of at least one precursor of silicon in the presence of a precursor of the dopant Sn(IV). The silicon precursor may be an organometallic compound of silicon, in general of the type SiR_{4-y}L_{y}, where R is an alkyl group, L is an alkoxide, acetate or halogenide group, and y=1 to 4 (for example, a silicic ester, such as TEOS or TMOS); the precursor of the dopant can be of the type R₂SnL₂ or R₃SnL or RSnL₃, where R and L have the meanings already specified.

The sol-gel reaction basically consists of the hydrolysis of the cited compounds, followed by the condensation thereof in an inorganic polymerisation. The reaction can be conducted in various solvents (for example, alcohols), is triggered by the addition of water and leads to the polymerisation of the silicic acid with the dopant, giving rise to the formation of a gel (known as “alcogel”). In said reaction, the precursor of the dopant behaves as a cross-linking agent in the framework of a classic organic polymerisation. The result consists of a porous, amorphous, matrix (known as “xerogel”), in which tin assumes a position that is prevalently substitutional to silicon, and does not give rise to separate phases of tin dioxide. The formation of the xerogel is completed with the slow evaporation of the solvents in a thermostatic chamber at a temperature of, indicatively, between 20° C. and 50° C. for a time that can range from some days to a few weeks in order to have an adequate elimination of the solvents. The matrix thus obtained is subsequently sintered via adequate thermal treatment in appropriate atmospheres.

An example of an appropriate thermal cycle is provided, by way of example, in the attached FIG. 1. In addition to the atmospheres indicated in FIG. 1, the sintering step can be conducted in vacuum conditions, or else in atmospheres of inert gas, such as H₂, Ar, He, etc., either pure or mixed with one another and/or with O₂.

The sintering process initially produces the elimination of the organic residue from the xerogel and subsequently, at temperatures of above 500-700° C., gives rise to densification of the matrix, with the loss of the typical porosity and the simultaneous phase separation of the substitutional tin in nano-aggregates of tin dioxide. The molar Sn:Si ratios obtainable are comprised between 1:100 and 1:2.

The synthesis is usable, according to this scheme, for the production of monoliths of transparent pyroceramic material with excellent optical qualities. The material thus obtained can serve for the production of fibres using the powder-in-tube and rod-in-tube methods, or can be used in bulk form for devices obtainable by direct two-dimensional writing of waveguides or by means of three-dimensional figures of refractive index or as material for the storage of holograms. It is moreover possible to obtain planar waveguide structures, for example by deposition on a glass substrate, using techniques known as “dip-coating” or “spin-coating”, of a sol obtained as a particular case of the compositions already cited.

Potentially, the material of the invention can be used in numerous other applications, such as, for example, the fabrication of devices based upon Bragg diffraction gratings, non-linear directional couplers, Mach-Zehnder devices and more generically non-linear optical switches, as well as holographic memories.

The advantages of the material according to the invention as compared to the known art are specified in what follows.

Unlike photorefractive glasses obtained by substitutional doping with tin (where the tin content must be maintained within levels such as to prevent phenomena of non-controlled segregation that would induce deterioration of the optical properties), the material of the invention is not subject to limitations of composition deriving from the very low solubility of tin in silica. It is thus possible to vary amply the content of SnO₂, achieving permanent variations of refractive index, for example by UV irradiation, with much higher values (according, precisely, to the content of tin) as compared to the known materials currently used for similar applications. In addition, the material of the invention does not require post-synthesis treatments (such as the treatments known as “hydrogen loading” or “flame brushing”), which are frequently used for increasing the photosensitive properties of some glasses, and is compatible with materials currently in use in optical devices (based principally upon materials derived from silica).

Another advantage of the invention derives from the fact that the interaction with the laser radiation necessary for obtaining variation of the index of refraction (used in the “writing” of the device or of the waveguide) is not limited to restricted ranges of wavelength at defect-absorption bands (as occurs, for example, for silica doped with germanium, boron or tin), but extends up to a fair range of the visible, thus rendering usable the 532-nm emission of a duplicated Nd YAG laser beam. This makes possible, among other things, irradiation of the material also through plastic coatings (typically ones that are transparent in the visible and, just beyond, in the ultraviolet), which otherwise should be removed before subjecting the material to UV treatment, with consequent considerable simplification of the process. The thermal stability of the variation of photo-induced index of refraction, measured after processes of thermal treatment carried out at temperatures of up to 700° C., is altogether suitable for the purpose and even better than that demonstrated by materials normally used in these applications.

All the properties found render the material suitable and innovative for the technological applications of photorefractive materials, above all in the field of optical communications, where the high photosensitivity is crucial for passing to planar-geometry micro-photon integrated devices, particularly with processes of direct writing of the waveguide.

According to a further aspect of the invention, the silica-based material with aggregates of SnO₂ of average dimensions lower than 2.5 nanometers presents non-linear optical properties, which are markedly influenced by confinement effects. Such properties of optical non-linearity render the material particularly suited for the fabrication of optical devices of an active type, such as for example directional couplers driven by optical control.

In the material of the invention, unlike other types of glass containing aggregates of semiconductors (such as, for example, glasses containing nanophases of CdS), both the vitreous matrix and the nanophase are oxides of elements of group IV, and thus possess a better thermochemical compatibility and consequently a greater stability. The properties of optical transmission of the material of the invention, which give rise to low attenuation in the near infrared, moreover render the material transparent in all three IR windows of interest in the branch of photonics (980, 1300, 1500 nm). On the other hand, the materials of the state of the art are rarely able to meet up to these requisites of compatibility with currently used opto-electronic devices and technologies.

The improvement of the state of the art, obtainable with the material proposed, is evident from the calculation of the figure of merit:
F=(⅛π)[Δ+(Eₑₓ−E_{g})]/E_{b}
for a non-linear directional coupler, where: A is the difference between the energy of the photons transmitted and E_{g}, which is the minimum energy of the electronic-interband excitations in macroscopic crystals; Eₑₓ is the energy of the fundamental state of the exciton in nanometric aggregates (corresponding to the minimum energy of the electronic excitations in pyroceram); and E_{b} is the binding energy of the exciton.

In examples of specimens of the invention, there have been calculated values of F equal to 2 or more times the typical values found in glasses containing semiconductor aggregates of Cd calcogenides. Taking into account that the production of pyroceramic materials containing SnO₂ at a concentration over 5 times greater than that of glasses with Cd calcogenides does not present technical problems, this result leads to an estimated reduction of one order of magnitude of the dimensions of devices of this type.

### BRIEF DESCRIPTION OF THE DRAWINGS

The invention is further described in the ensuing non-limiting examples of embodiment, with reference to the annexed drawings, in which:

FIG. 1 illustrates schematically a sintering cycle forming part of the process of fabrication of the material according to the invention;

FIG. 2 illustrates the results of experimental tests of measurement of the variation of the index of refraction (according to the number of UV-laser pulses) conducted on specimens of material according to the invention and reference specimens;

FIG. 3 gives the results of experimental tests of measurement of the variation of refractive index according to the molar fraction of tin dioxide (after 5000 laser pulses−energy per pulse approximately 150 mJ/cm²) conducted on specimens of material according to the invention and on reference specimens; and

FIG. 4 gives the results of experimental tests of measurement of the transmittance obtained using the Z-scan technique at 1064 nm on a material according to the invention.

### BEST MODE FOR CARRYING OUT THE INVENTION

### EXAMPLE 1

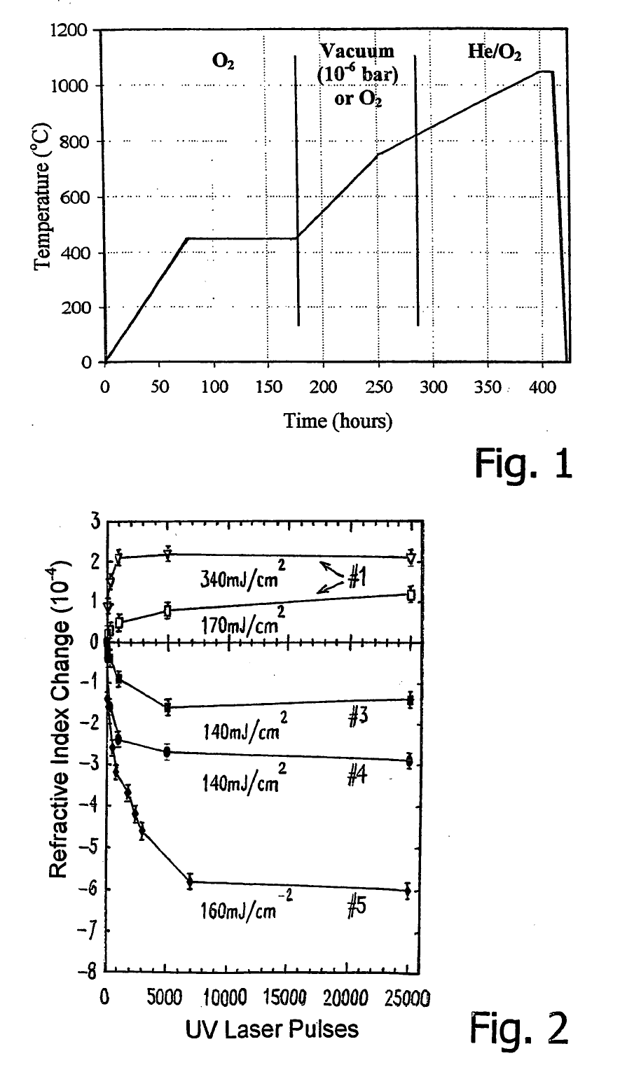

Silica-based materials doped with variable amounts of tin were made, using the basic technique described previously in its broad lines and, in particular, the sintering cycle of FIG. 1. The specimens indicated in Table 1 below were obtained and analyzed.

TABLE 1

| specimen | | physical |
|---|---|---|
| # | SnO₂ (ppm) | state |
| 1 | 4000 | Glass |
| 2 | 5000 | Glass |
| 3 | 16000 | Pyroceram |
| 4 | 24000 | Pyroceram |
| 5 | 50000 | Pyroceram |
| 6 | 150000 | Pyroceram |

At low concentrations (specimens 1 and 2), the tin is included in silica in a position substitutional to silicon, in tetrahedral sites, without formation of separate phase, as may be noted from measurements of photoluminescence and electronic paramagnetic resonance and as is, on the other hand, amply known. For high concentrations (specimens 3, 4 and 5) there is, instead, observed the formation of SnO₂ crystallites with an average size of approximately 10-15 nm using X-ray diffraction analysis and Raman spectroscopy of the width of the diffraction peaks and of the vibrational modes of the SnO₂ phase.

The presence, dimensions, and dispersion in dimensions of the aggregates of SnO₂ were analysed in detail, by means of measurements of electronic-transmission microscopy: uniformly distributed crystallites were found, in which it was possible to observe the entire length of the reticular planes of the crystal with spacing corresponding to that of cassiterite.

The statistical analysis of different images under the electronic microscope on different specimens confirmed that the average dimensions of the crystallites are approximately 10 nm, as long as there are not adopted particular conditions of preparation aimed at obtaining smaller dimensions. In this case, aggregates are obtained with average dimensions of up to approximately 1-2 nm and a relatively narrow dispersion of dimensions, equal to approximately 20% of the average ray.

A confirmation of the actual structure and morphology of the material revealed by means of statistical analysis of the TEM images is deduced from experimental measurements of optical properties (optical absorption, photoluminescence spectra, etc.; the results are not reproduced here for reasons of simplicity).

### EXAMPLE 2

The parameters were identified on which it is necessary to intervene for controlling effectively the dimensions of the aggregates of SnO₂; namely:
1) concentration of the tin (in the form SnO₂) in the step of sol-gel reaction: there was revealed a relation of proportionality between the concentration of SnO₂ and the dimensions of the aggregates; by way of example, in order to obtain aggregates of dimensions of 5 to 15 nm it is possible to work with concentrations of SnO₂ of up to over 30 mol %, and in order to obtain aggregates of dimensions smaller than 2.5 nm it is possible to work with concentrations of SnO₂ not higher than approximately 5 to 8 mol %;
2) partial pressure of oxygen (or other gas used) during the sintering step: in this case, the lower the partial pressure, the greater the dimensions of the aggregates; for example, in order to obtain aggregates of dimensions higher than 10 nm it is possible to work under partial pressure lower than 5 mBar, and in order to obtain aggregates of dimensions smaller than 2.5 nm it is possible to work under partial pressure comprised between 100 and 1000 mBar;
3) maximum temperature reached by the sintering treatment: a direct proportionality can be attributed between the sintering temperature and the dimensions of the aggregates: once again by way of example, sintering can be performed at a temperature higher than 1000° C. to obtain aggregates of dimensions above 5 nm, and at a temperature of between approximately 800° C. and approximately 950° C. to 1000° C. to obtain aggregates of dimensions smaller than 2.5 nm.

It is possible to intervene on each of the three parameters individually or on two or three parameters in combination, then varying the value of each parameter in relation to the other: just one parameter could be sufficient to achieve the desired result, but the same result can be achieved with various combinations of the parameters. The values of the parameters herein provided are consequently purely indicative.

Specimens of materials according to the invention were prepared, as summarized in what follows. In all the cases, a sol was prepared according to the general procedure given previously: in an appropriate polypropylene container there were set to react 2 ml of tetraethoxysilane (TEOS) in 6 ml of absolute ethanol; there were then added different amounts of tin dibutyl-diacetate; and there were finally added 1.8 ml of H₂O to bring about hydrolysis of the organometallic precursors.

The sol thus prepared was then set in a thermostatic chamber, in which the sol-gel transition was promoted, enabling at the same time the slow evaporation of the solvent. Once desiccation was completed, the resulting xerogel was sintered.

The results of the synthesis according to the sintering parameters and the concentration of tin were the following:
Specimen 7:
   Molar content of SnO₂: 3%
   Sintering: treatment in vacuum conditions (10⁻² to 10⁻³ torr) from 450° C. to 850° C., followed by treatment in an He:O₂ mixture at 0.5% of O₂ up-to completion of sintering.
   Final sintering temperature: 1050° C.
   Average dimension of the aggregates of SnO₂: 15 nm
Specimen 8:
   Molar content of SnO₂: 15%
   Sintering: in atmosphere of O₂ at 99.99% up to completion of sintering.
   Final sintering temperature: 1050° C.
   Average dimension of the aggregates of SnO₂: 10 nm
Specimen 9:
   Molar content of SnO₂: 5%
   Sintering: in atmosphere of O₂ at 99.99% up to completion of sintering.
   Final sintering temperature: 1050° C.
   Average dimension of the aggregates of SnO₂: 6 nm
Specimen 10:
   Molar content of SnO₂: 3%
   Sintering: in atmosphere of O₂ at 99.99% up to completion of sintering.
   Final sintering temperature: 1150° C.
   Average dimension of the aggregates of SnO₂: 4 nm
Specimen 11:
   Molar content of SnO₂: 3%
   Sintering: in atmosphere of O₂ at 99.99% up to completion of sintering.
   Final sintering temperature: 950° C.
   Average dimension of the aggregates of SnO₂: 2 nm
Specimen 12:
   Molar content of SnO₂: 5%
   Sintering: in atmosphere of O₂ at 99.99% up to completion of sintering.
   Final sintering temperature: 850° C.
   Average dimension of the aggregates of SnO₂: 2 nm

### EXAMPLE 3

With a procedure similar to those previously illustrated, and with a further variation of the process parameters referred to above, further specimens of materials were prepared having different dimensions of aggregates of SnO₂, in particular with average dimensions of some tens of nm (20 to 100 nm). In these materials, the typical optical characteristics tend to worsen considerably, without, however, preventing, in absolute terms, a possible use of the material. Specimens of materials having non-linear properties were prepared, with dimensions of the aggregates of 2.5 nm and smaller.

### EXAMPLE 4

### Measurements of Photosensitivity

The photosensitivity of the specimens of material of the preceding Example 1 was evaluated by means of measurements of index of refraction at 980 nm using the prism-coupler technique. The mathematical treatment of an adequate statistical set of data enabled a determination of the variations of index of refraction with an uncertainty of approximately 5×10⁻⁵. There were then studied the effects of exposure to UV radiation using the fourth harmonic at 266 nm of an Nd-YAG pulsed laser (with a frequency of 10 Hz, and a pulse duration of 6 ns).

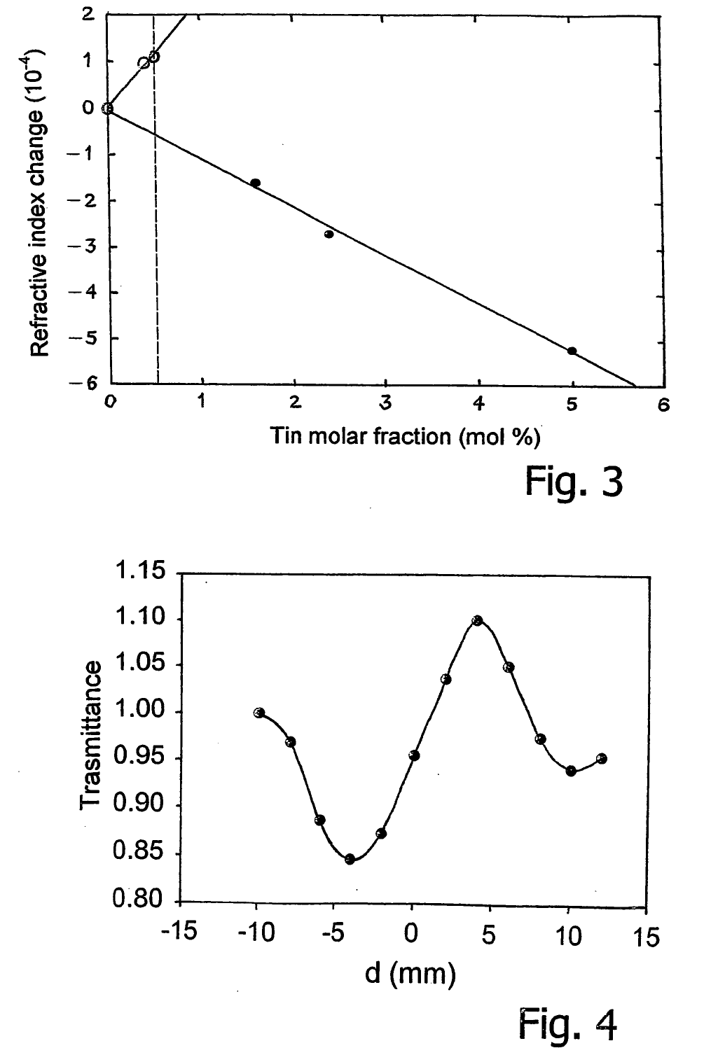

FIG. 2 gives the data of variation of refractive index according to the number of laser pulses, both in glasses and in pyroceram, at various densities of energy per pulse. These results highlight that the doping with tin does not induce only positive variations, as observed in the glasses, but also negative variations. Instead, all the results culled show that the negative photosensitivity is strictly correlated to the segregation of SnO₂: the segregation of SnO₂ is systematically accompanied by negative variations in the index of refraction. It is moreover observed that the variation of refractive index increases proportionally with the content of SnO₂, as illustrated in FIG. 3.

Similar results were obtained using radiation at 532 nm of the second harmonic of the Nd YAG laser: in this case, using pulse powers four times higher, there were obtained variations of index of refraction equal to over ⅔ of the previous ones.

### EXAMPLE 5

### Non-linear Properties of the Material

The properties of optical non-linearity of the material according to the invention were investigated (the results are given in FIG. 4) at 1064 nm using the Z-scan technique. There was detected a non-linearity of the third order of size of approximately one order of magnitude higher than the typical values measured in glasses doped with cadmium calcogenides, known for example from the publication [6], W. Nie, “Optical nonlinearity: phenomena, applications, and materials”, Adv. Mater. 5, 520. (1993).

The high non-linearity, together with the low losses of absorption (comparable to those of silica), the high fraction in volume of phase segregated and the small dimensions of the crystallites of SnO₂ render the material particularly suitable for use in non-linear directional coupler devices.

### EXAMPLE 6

### Applications of the Material in Elements and Optical Devices

With the materials obtained following the procedure adopted in the foregoing examples, devices of various types have been made, namely:
optical elements, in the form of optical fibres, planar structures and three-dimensional bodies;
optical elements, in which a waveguide has been obtained by a substantially permanent variation of index of refraction by irradiation with laser light according to the techniques already described, on which there has been permanently written an interferogram or an area (or volume) with different index of refraction;
optical waveguide devices, comprising at least one waveguide, made with the material of the invention and in which there has been induced a substantially permanent variation of index of refraction.

The geometry, structure and techniques of fabrication of said devices are widely known (and in some cases reported previously) and are not therefore described herein or illustrated for reasons of simplicity, since the person expert in the branch is fully able to make said devices once instructed by the present invention to use the material of the invention.

In particular, the functional structure (waveguide, grating, hologram, input and output channels, etc.) of the devices has been at least in part produced by direct writing by electromagnetic radiation with phase mask, via holographic means, or via interferometric meters, or by means of scanning with an appropriate focused laser beam.

1. A glass ceramic material with a base of silica and tin dioxide, particularly for optical applications, comprising a matrix of vitreous silica in which there are dispersed crystalline aggregates of tin dioxide, the material being characterized in that said aggregates have controlled dimensions that are on average lower than a pre-set threshold and such that the material is photosensitive and substantially transparent.

2. The glass ceramic material according to claim 1, characterized in that said aggregates have on average dimensions smaller than approximately 100 nm and preferably smaller than approximately 15 nm.

3. The glass ceramic material according to claim 1, characterized in that said matrix is essentially made of silica and is substantially devoid, apart from said aggregates of tin dioxide, of other dopants.

4. The glass ceramic material according to claim 1, characterized in that it presents negative variations of index of refraction when exposed to electromagnetic radiation.

5. The glass ceramic material according to claim 1, characterized in that said aggregates have on average dimensions smaller than approximately 2.5 nm, and the material presents non-linear optical properties.

6. The glass ceramic material according to claim 1, characterized in that it has a transmittance in the visible and in the infrared corresponding to an attenuation lower than 1 dB/cm.

7. The glass ceramic material according to claim 1, characterized in that it contains up to 30 mol % of crystallized tin dioxide in said aggregates of controlled dimensions.

8. An optical waveguide element, in particular in the form of fibres, planar structures or three-dimensional bodies, characterized in that it is made of a glass ceramic material according to claim 1.

9. The optical waveguide device, comprising at least one waveguide made of a photosensitive material and in which there is induced a substantially permanent variation of index of refraction, the device being characterized in that said material is a glass ceramic material according to claim 1.

10. A process for fabricating an optical device, said device being made of a glass ceramic material according to claim 1 and having a functional structure, in particular a waveguide, a grating, a hologram, input and output channels of a generic non-linear device, etc., which is at least in part produced by direct writing by electromagnetic radiation with phase mask, via holographic means, or with interferometer, or by means of scanning with an appropriate focused laser beam.

11. A process for making a glass ceramic material having a matrix of vitreous silica in which are dispersed crystalline aggregates of tin dioxide of controlled dimensions, said process comprising a step of sol-gel reaction of respective precursors of silica and tin, and a step of sintering the gel resulting from said sol-gel reaction, said process being characterized in that the dimensions of said aggregates of tin dioxide are controlled by varying the concentration of tin in said step of sol-gel reaction, and/or the partial pressure of oxygen in said sintering step, and/or the maximum temperature reached in said sintering step.

12. The glass ceramic material with a base of silica and tin dioxide, particularly for optical applications, and the process of fabrication of said material, and devices made with said material, substantially as described herein.
